(19) United States
(12) Patent Application Publication
(10) Pub. No.: US 2015/0260308 A1
(43) Pub. Date: Sep. 17, 2015

(54) DIRECTIONAL CONTROL VALVE

(71) Applicants: Lawrence J. Fry, Lexington, KY (US); David Biddle, Stamping Ground, KY (US); Adi Peshkess, Richmond, KY (US)

(72) Inventors: Lawrence J. Fry, Lexington, KY (US); David Biddle, Stamping Ground, KY (US); Adi Peshkess, Richmond, KY (US)

(73) Assignee: 1953 Mercer Road, Lexington (KY)

(21) Appl. No.: 14/424,823

(22) PCT Filed: Aug. 30, 2013
(86) PCT No.: PCT/US2013/057500

§ 371 Date: Feb. 27, 2015

Related U.S. Application Data
(60) Provisional application No. 61/695,594, filed on Aug. 31, 2012.

(51) Int. Cl. F16K 31/60; F16K 11/07; F16K 11/065; F16K 31/06

(52) U.S. Cl. CPC F16K 31/602; F16K 31/0617; F16K 11/0704; F16K 11/0655

(57) ABSTRACT

A directional control valve assembly includes a fluid control valve having a valve element defining a longitudinal axis along which the valve element is translatable. The valve element is cooperative with one or more fluid passages to define fluid pathways to and from the fluid control valve. A housing is secured to the fluid control valve and positioned to receive a portion of a connecting member coupled to the valve element. A handle is pivotally connected to the housing and operatively coupled to the connecting member such that rotation of the handle causes translation of the valve element within the fluid control valve. The handle is movable from a locked position to an unlocked position permitting handle rotation. The handle is not biased by a spring into the locked position.

### BACKGROUND

The present invention relates to a directional control valve for controlling fluid flow to and from hydraulic and/or pneumatic machinery.

### SUMMARY

In one embodiment a directional control valve assembly includes a fluid control valve having a valve element defining a longitudinal axis along which the valve element is translatable. The valve element is cooperative with one or more fluid passages to define fluid pathways to and from the fluid control valve. A housing is secured to the fluid control valve and positioned to receive a portion of a connecting member coupled to the valve element. A handle is pivotally connected to the housing and operatively coupled to the connecting member such that rotation of the handle causes translation of the valve element within the fluid control valve. The handle is movable from a locked position to an unlocked position permitting handle rotation. The handle is not biased by a spring into the locked position.

In one embodiment of a method for controlling the position of a directional control valve, in which the directional control valve includes a solenoid-actuated plate and a handle operably coupled to the plate, the method includes energizing the solenoid to move the plate to a first plate position. The method also includes manually pivoting the handle to move the plate to a second plate position. The method further includes moving the handle to lock the plate in the second plate position without the assistance of a biasing element.

Other aspects of the invention will become apparent by consideration of the detailed description and accompanying drawings.

### BRIEF DESCRIPTION OF THE DRAWINGS

FIG. 1 is a perspective view of a directional control valve.

FIG. 2 is a perspective sectional view of the directional control valve taken along line 2-2 of FIG. 1.

FIG. 3 is a partial exploded view of a handle assembly of the directional control valve of FIG. 1.

FIG. 4 is a partial cross sectional view of the directional control valve of FIG. 1 illustrating linear movement of the handle.

FIG. 5 is a partial cross sectional view of the directional control valve of FIG. 1 illustrating rotational and linear movement of the handle.

FIGS. 6A-C are partial cross-sectional views illustrating three locked positions of the directional control valve of FIG. 1.

FIG. 7 is a perspective view of another directional control valve.

FIG. 8 is an exploded view of a portion of the directional control valve of FIG. 7.

FIG. 9 is a perspective sectional view of the directional control valve taken along line 9-9 of FIG. 7.

FIG. 10 is a partial sectional view of the directional control valve of FIG. 7 locked in a first position.

FIG. 11 is a partial sectional view of the directional control valve of FIG. 7 unlocked in the first position.

FIG. 12 is a partial sectional view of the directional control valve of FIG. 7 rotating from the first position to a second position.

FIG. 13 is a partial sectional view of the directional control valve of FIG. 7 locked in the second position

FIGS. 14A-C are side views illustrating three locked positions of the directional control valve of FIG. 7.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. And as used herein and in the appended claims, the terms “upper”, “lower”, “top”, “bottom”, “front”, “back”, and other directional terms are not intended to require any particular orientation, but are instead used for purposes of description only.

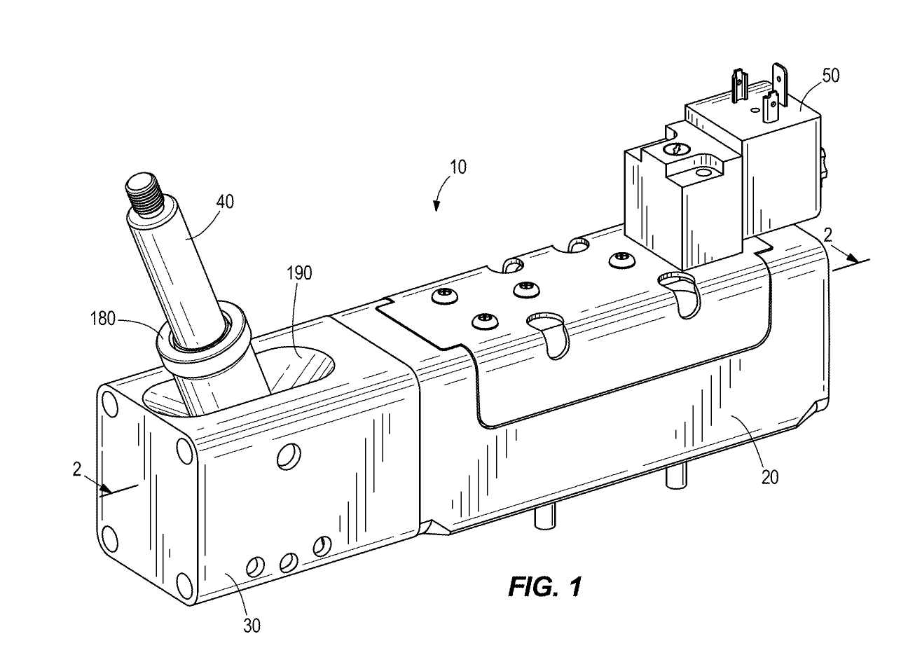

FIGS. 1-3 illustrate a directional control valve 10 for controlling the flow of fluid to mechanical equipment. As one example, the control valve 10 can be used with a trailer (now shown) to control the opening and closing of the trailer gates. The directional control valve 10 can be located directly on or nearby the equipment to be controlled, with rigid or flexible tubing (not shown) conveying the fluid passing to and from the valve 10.

The control valve 10 includes a valve body 20, a housing 30 adjacent the valve body 20, and a handle 40 for manual operation. The illustrated valve 10 is a solenoid operated valve and therefore includes a relay 50 for electrically energizing the valve 10. Alternatively, the solenoid valve may be powered in any manner locally or remotely. In other embodiments, the valve 10 need not be a single solenoid valve but can be, for example, another fluid control valve such as a double solenoid valve, a single or double air pilot operated valve, or a manual valve.

The valve body 20 houses a carrier 100 that translates a valve element or plate 102 along a generally longitudinal axis 104. The valve element 102 may also take the form of a spool or sliding shoe, depending on the configuration of the valve body 20. The plate 102 is movable within the valve body 20 to simultaneously cover and uncover a plurality of passages 112 to define fluid pathways into and out of the valve 10, as is known by those of ordinary skill. A spring 120 biases the plate 102 in one direction in the absence of energization of the solenoid. In embodiments in which the valve 10 is a double solenoid valve, the biasing spring 120 is not necessary and can be eliminated.

The carrier 100 surrounds and is secured to the first end 130 of a rod 134, the second end 138 of which is coupled to a connecting member or shaft 144 such that a fixed relationship is maintained between the plate 102 and the connecting shaft 144. An end 150 of the connecting shaft 144 defines an opening 154 spanned by a connecting pin 158.

The connecting shaft 144 extends from the valve body 20 into the interior space 164 of the housing 30. One or more locking members or pins 170 offset to one side of the translating path of the connecting shaft 144 span or substantially span the space 164. Although illustrated with three circumferentially spaced apart locking pins 170, one, two, or four or more locking pins 170 may be present within the interior space 164. As such, the locking pins 170 are entirely contained within the housing 30. The pins 170 define separate parallel axes 174.

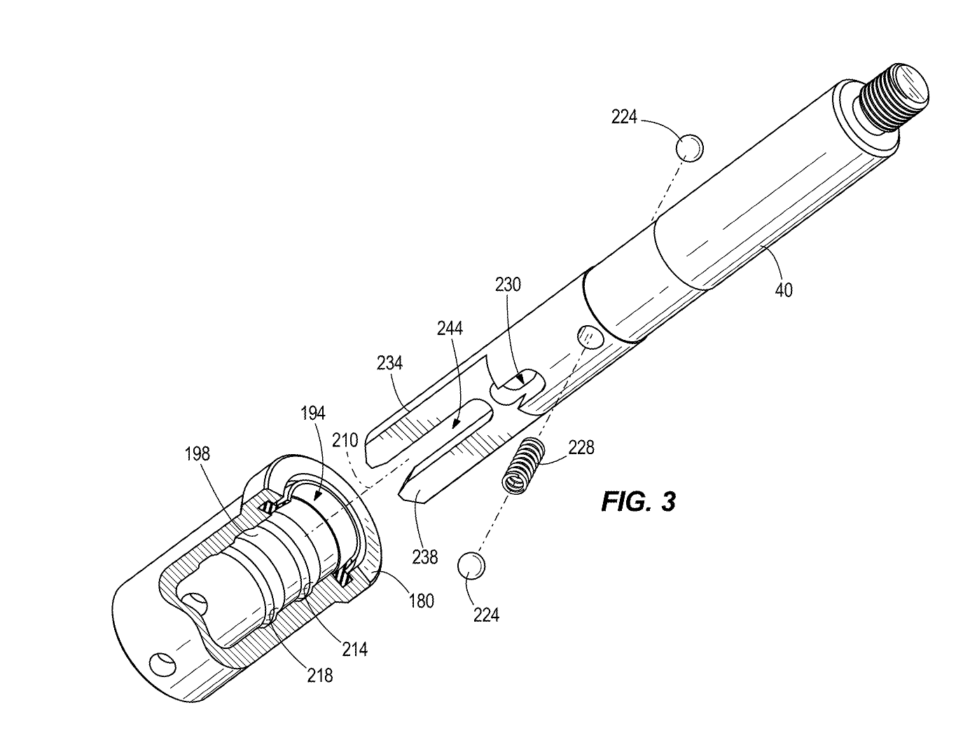

A sleeve 180 is pivotally connected to the housing 30 with a pivot pin 184 at a point offset to the other side of the path of the connecting shaft 144 from the locking pins 170. The housing 30 is formed with a depression 190 to permit rotation of the sleeve 180 about the pivot pin 184 without interference. Referring to FIG. 3, the sleeve interior 194 is formed from a cylindrical wall 198 that is sized to receive the handle 40 and that includes one or more notches or grooves 214, 218. Specifically, the wall includes a first notch 214 and a second notch 218. Opposing detents 224 in the handle 40 are biased with a spring 228 and configured to mate with each of the notches 214, 218 in the cylindrical wall 198. The handle 40 further features an intermediate channel 230, and legs 234, 238 that define a locking channel 244. Linear movement of the handle 40 within the sleeve 180 along a handle longitudinal direction 248 is bounded by the interaction of the pivot pin 184 with the intermediate channel 230. The locking channel 244 is sized to receive one of the locking pins 170 upon linear movement of the handle 40. When not engaged with a locking pin 170, the sleeve 180 and handle 40 are free to rotate about the pivot pin 184.

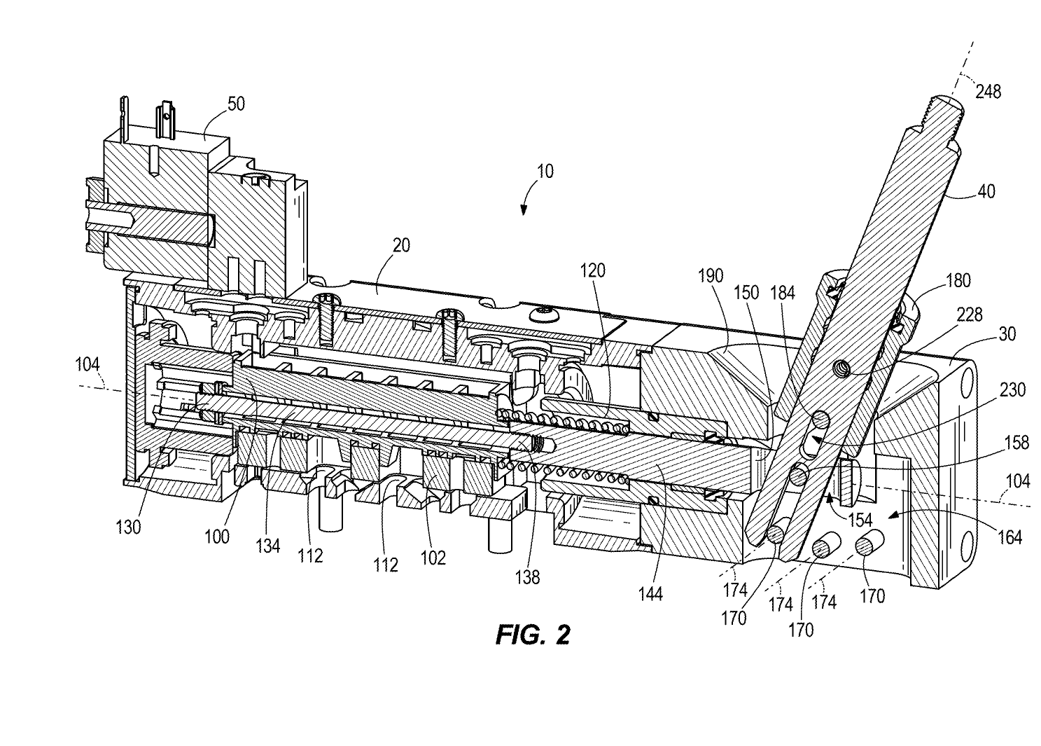

Referring to FIGS. 2, 4, and 5, in operation, the control valve 10 can be placed in an unlocked state and a locked state. In the unlocked state, the plate 102 can be translated to modify the fluid flow path both locally through rotation of the handle 40 and remotely upon energization of the solenoid. In the locked state, the handle 40 is blocked from rotational movement, which fixes the position of the plate 102 through the connecting pin 158.

Changing the valve 10 between the unlocked and locked states is accomplished through linear movement of the handle 40. Specifically, an operator is able to move the handle 40 linearly within the sleeve 180 between a rotationally unlocked position and a rotationally locked position. Tactile feedback generated by alignment of the detents 224 with the first notch 214 in the sleeve 180 signals that the handle 40 is in a rotationally unlocked position while alignment of the detents 224 with the second notch 218 signals that the handle 40 is in a rotationally locked position. When the detents 224 are so mated with the first or second notches 214, 218, the handle 40 will maintain its linear position within the sleeve 180 upon release of the handle 40. The handle 40 is therefore not inherently biased into a locked or unlocked position via a spring or any other biasing element or force.

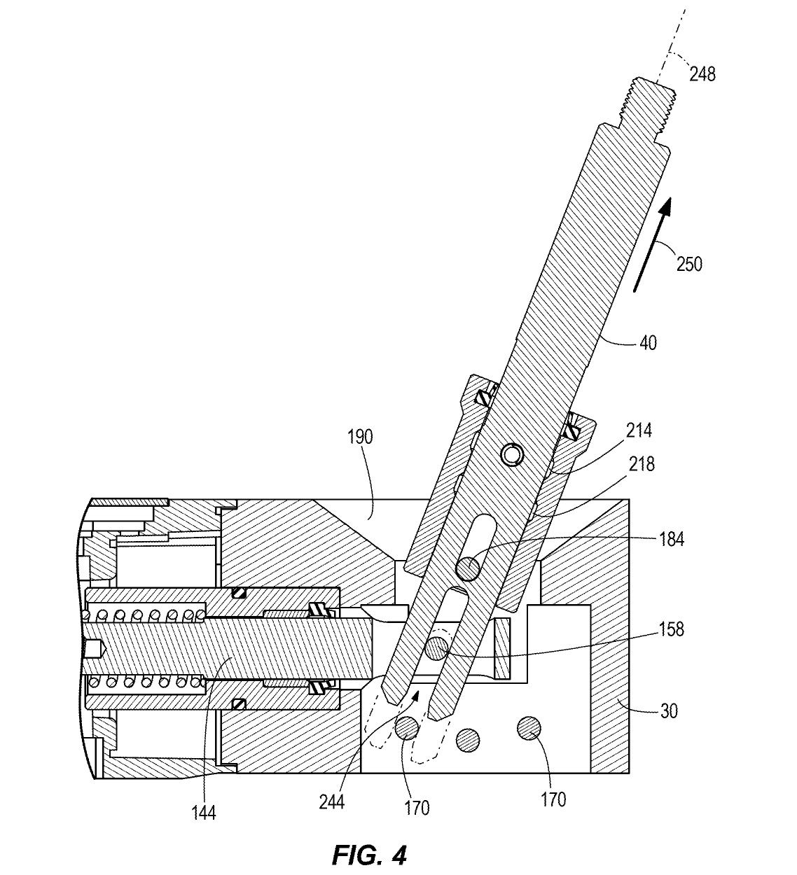

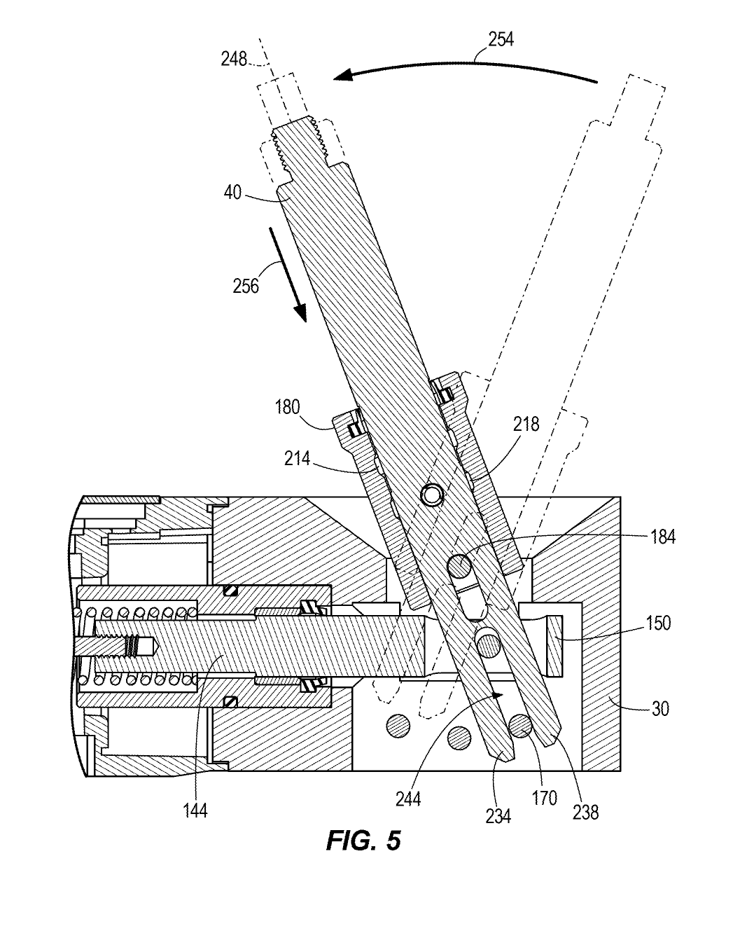

As shown in FIG. 4, to unlock the valve 10, the operator pulls up on or extracts the handle 40 from the housing 30, as shown by arrow 250, to release the detents 224 from the second notch 218 and seat the detents in the first notch 214. This concurrently moves the locking channel 244 away from engagement with a locking pin 170, freeing the plate 102 for solenoid operation and the influence of the biasing spring 120. Upon energization of the solenoid with a source of power, because the handle legs 234, 238 fail to engage or contact any of the locking pins 170, the handle 40 is free to rotate about the pivot pin 184, as shown by arrow 254 of FIG. 5, and the plate 102 is free to translate within the valve housing 20 from a first plate position to a second plate position. Unlocking the valve 10 in this manner also permits the operator to 1) manually move the handle 40, and thus the plate 102, incrementally between an infinite number of plate positions and/or 2) move the plate 102 to a defined plate position for a certain period of time before returning or moving the plate 102 to another position. Such manual manipulation through the handle 40 affords precise control of the supply fluid, which may be desired in certain applications.

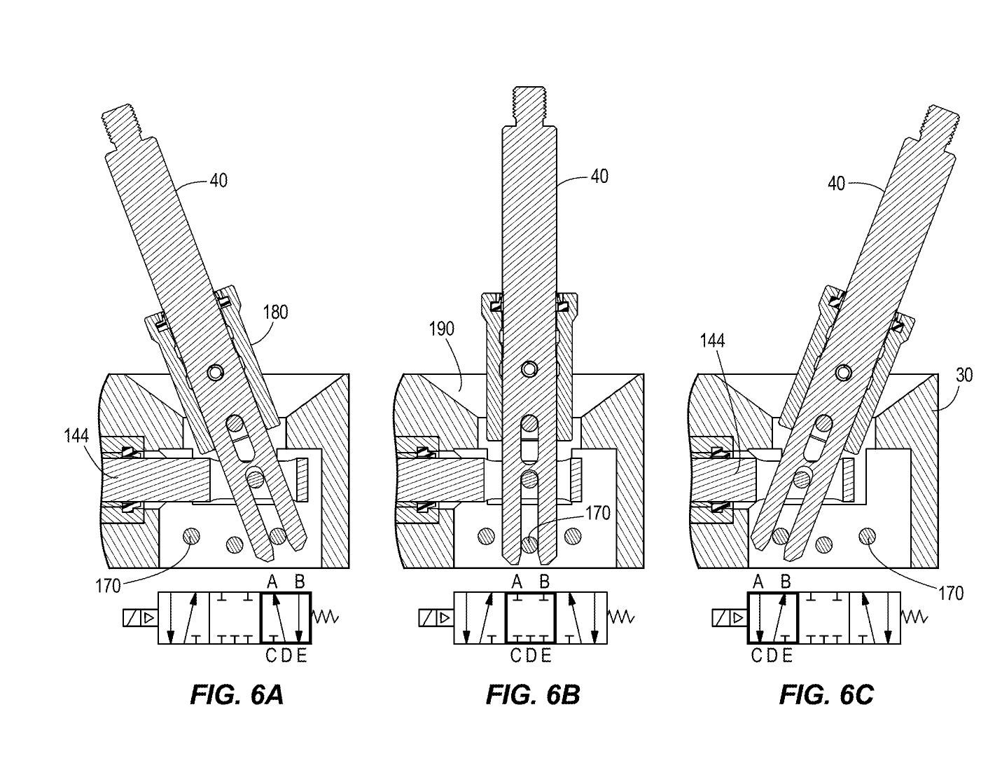

Referring again to FIG. 5, to lock the handle 40 and thus the plate 102 in place the operator depresses the handle 40 (arrow 256), disengaging the detents 224 from the first notch 214. After sufficient linear movement, the operator will “feel” the detents 224 engage the second notch 218. If aligned with a locking pin 170, this concurrently passes the locking channel 244 over the pin 170. In this depressed or locked position, a torque applied to the handle 40 about the pivot pin 184 will be resisted by the engagement of the handle legs 234, 238 with the locking pin 170, rotatably fixing the handle 40 and locking the plate 102. Referring to FIGS. 6A-6C, for example, the plate 102 can be locked in the first plate position in which Port A communicates with Port D, Port B communicates with Port E, and Port C is blocked (FIG. 6A), the second plate position in which Port A communicates with Port C, Port D communicates with Port B, and Port E is blocked (FIG. 6C), or a third plate position in which all of Ports A-E are blocked (FIG. 6B).

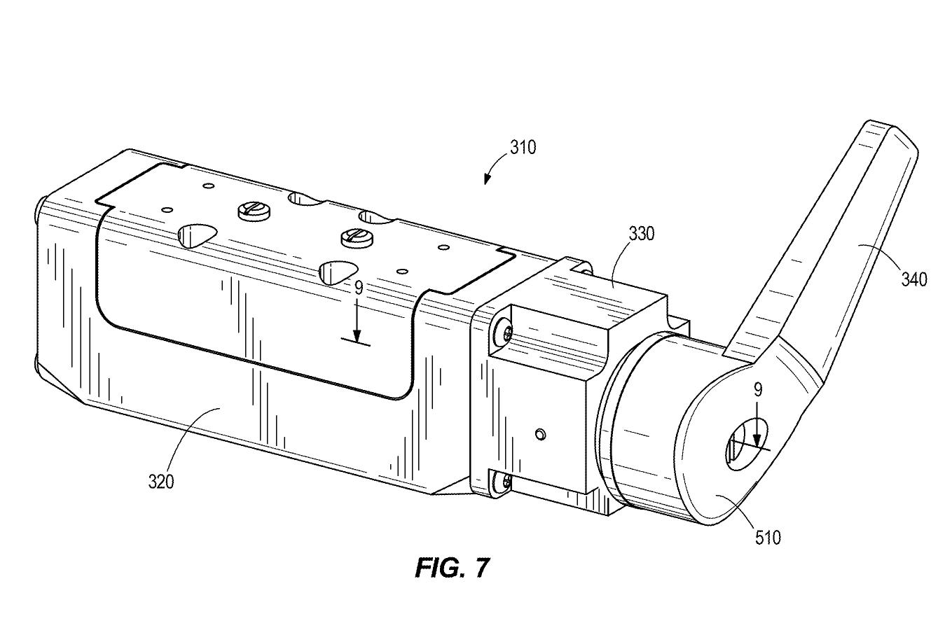

FIGS. 7-9 illustrate another directional control valve 310 for controlling the flow of fluid to mechanical equipment. The control valve 310 includes a valve body 320 similar to the valve body 20, a housing 330 adjacent the valve body 320, and a handle 340 for manual operation. As with the previously described embodiment, the valve 310 is a solenoid operated valve and includes the necessary electrical connections (not shown) for solenoid operation. In other embodiments, the valve 310 need not be a single solenoid valve but can be, for example, another fluid control valve such as a double solenoid valve, a single or double air pilot operated valve, or a manual valve.

The valve body 320 houses a carrier 400 that translates a valve element or plate 402 along a generally longitudinal axis 404. The plate 402 is affixed through the carrier 400 to a connecting rod 410 via a connecting block 414. The connecting rod 410 includes a first portion 420 having a first radius and a second portion 424 having a second radius larger than the first radius. A transverse aperture 440 configured to receive a transfer pin 444 extends through the second portion 424, which also includes an end face 450 abutting a biasing spring 454.

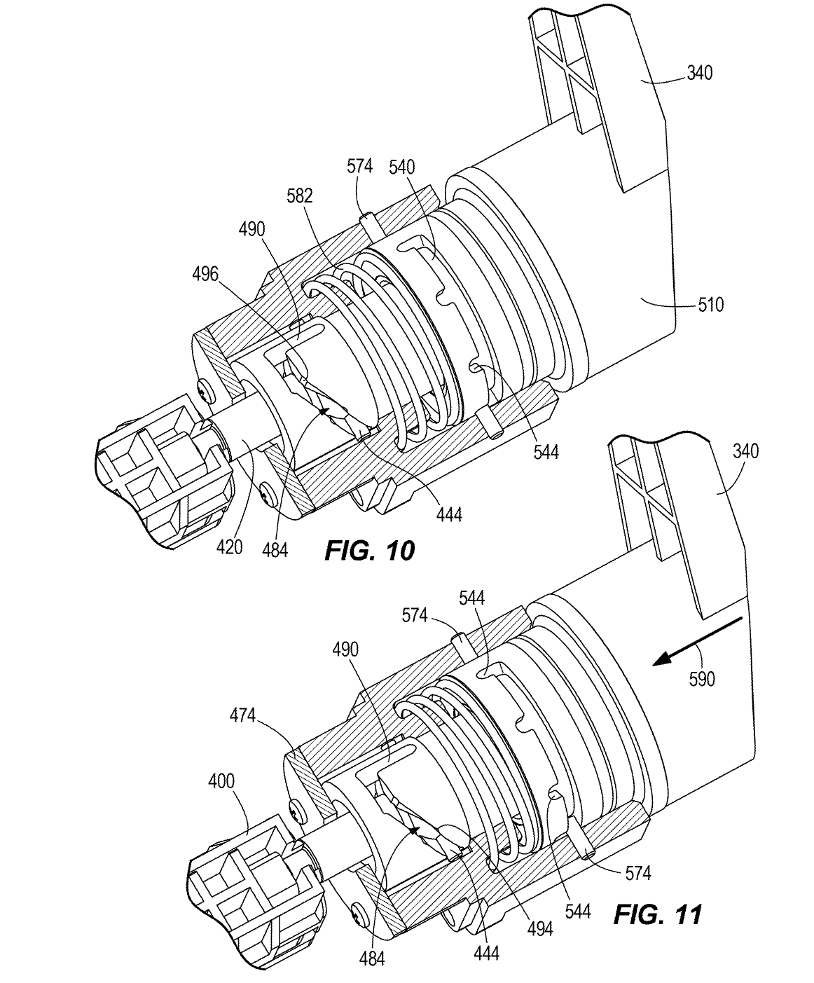

When assembled, the biasing spring 454 and the second portion 424 of the connecting rod 410 are positioned within a cavity 460 of an actuating arm 464 while the first portion 420 passes through an orifice 470 of a disc 474 disposed between the housing 330 and the carrier 400. One end 480 of the actuating arm 464 includes a transfer passage 484 that rotates about the transfer pin 444 and is oriented to transform rotation of the actuating arm 464 into translation of the connecting rod 410 along the axis 404. Referring also to FIGS. 10-13, sets of indentations 492, 494, 496 along the transfer passage 484 correlate to predefined plate positions, which will be further detailed below, and an end section 490 of the passage 484 is oriented in parallel with the longitudinal axis 404. The other end 498 of the actuating arm 464 transitions to a projection 500 with generally flat opposing sides 504. A lip 506 separates the ends 480, 498.

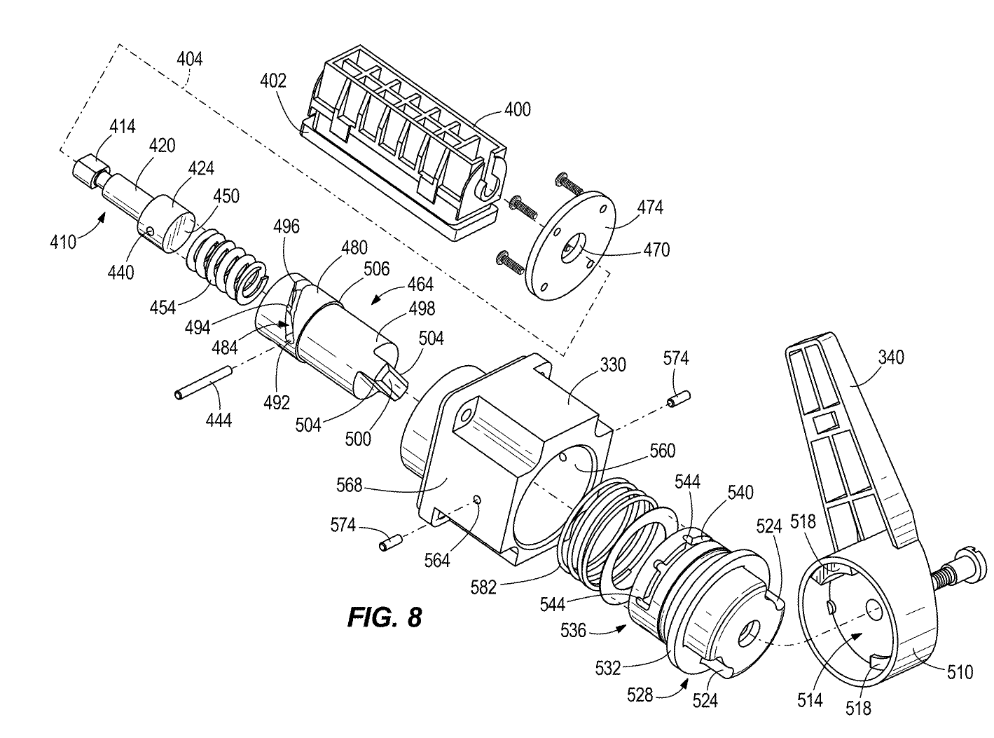

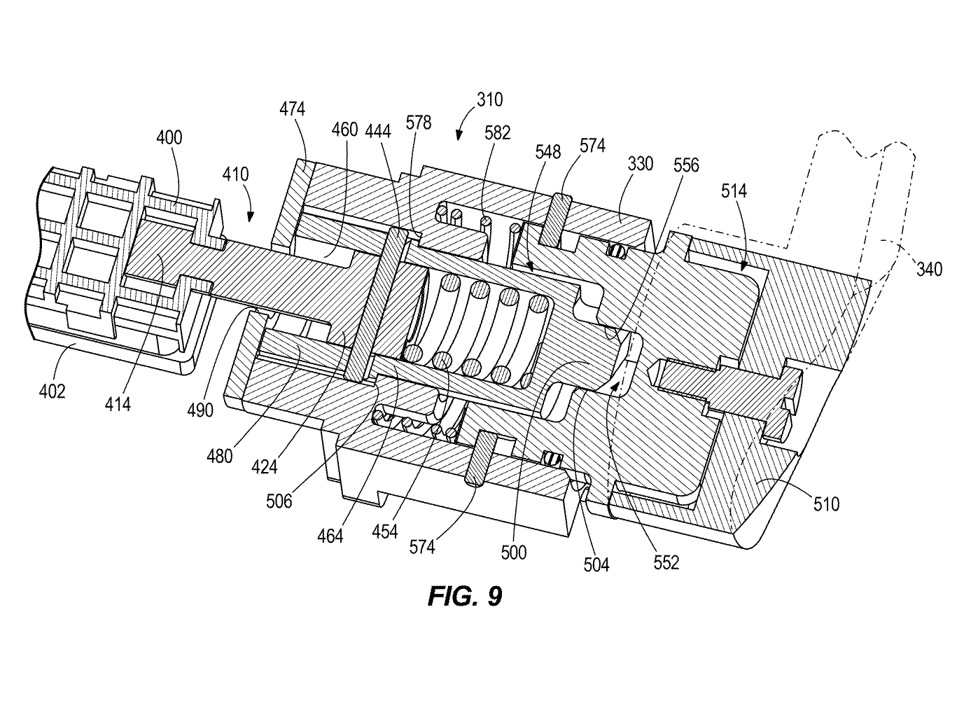

As seen in FIG. 8, the handle 340 extends from a handle hub 510 defining a cavity 514 containing two diametrically opposed semi-annular ribs 518. The ribs 518 are configured to engage corresponding grooves 524 formed in a first side 528 of a rotatable actuating member 532. The opposite second side 536 of the actuating member 532 includes opposing arcuate locking pin channels 540, each presenting two or more circumferentially spaced notches 544. The actuating member 532 is formed with a pocket 548 that transitions to a well 552 (FIG. 9) defining an interior surface 556. The pocket 548 is sized to slidingly receive the end 498 of the actuating arm 464, with the projection 500 thereby situated within the well 552. The second side 536 of the actuating member 532 and the actuating arm 464 are both positioned within a cylindrical bore 560 of the housing 330. When so assembled, lateral apertures 564 in the wall 568 of the housing 330 fixedly dispose a pair of locking pins 574 within the path of the locking pin channel 540. In addition, the lip 506 of the actuating arm 464 abuts a shoulder 578 formed in the housing 330 such that a biasing spring 582 tends to separate the actuating member 532 from the actuating arm 464.

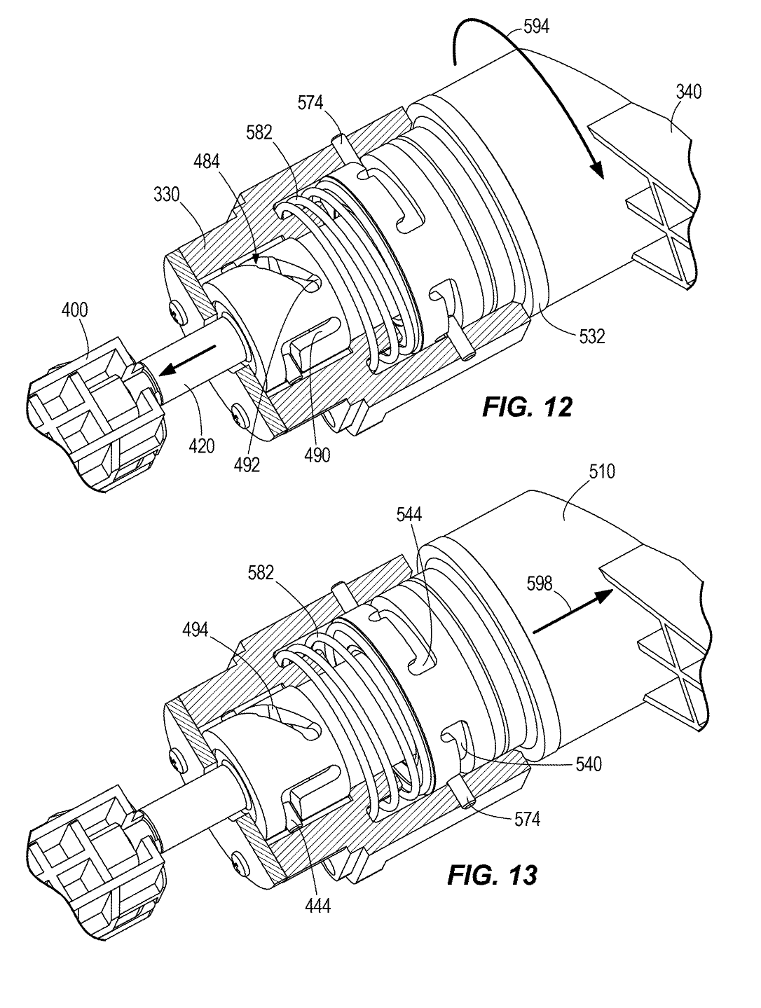

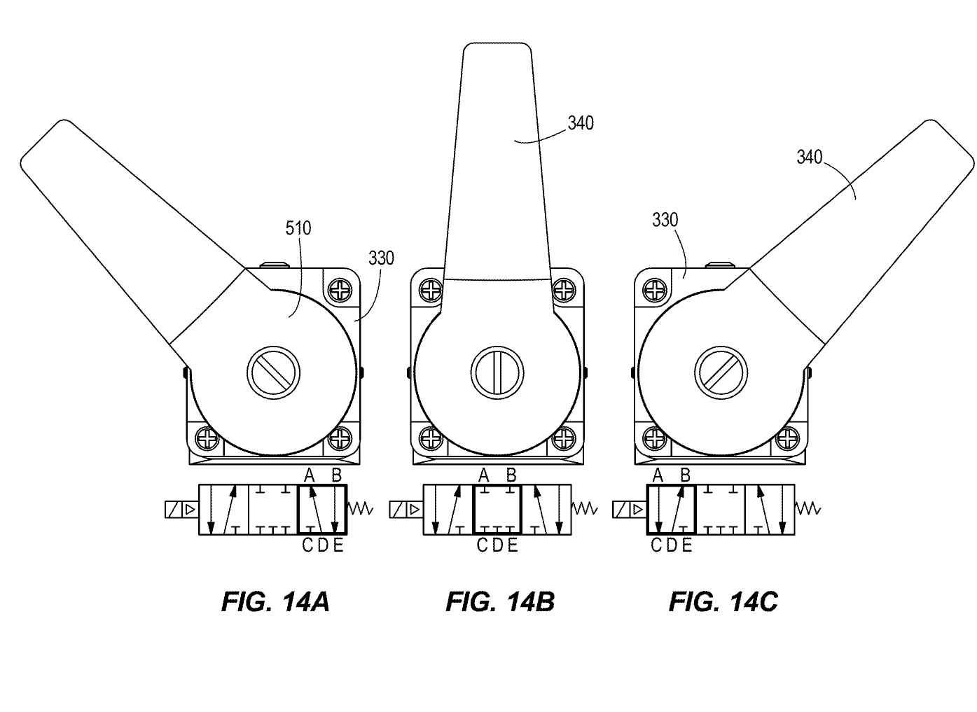

In operation, the control valve 310 is rotationally actuatable via local manipulation of the handle 340. Referring to FIG. 10, the handle 340 is in a locked state whereby rotation of the actuating member 532 is resisted by the interaction of the locking pins 574 with the notches 544. To disengage the locking pins 574, the operator depresses the handle 340 and/or hub 510 against the spring 582 as depicted by the arrow 590 of FIG. 11. This removes the notches 544 from the pins 574 and exposes the pins 574 to the locking pin channel 540. As shown in FIG. 11, with this orientation the transfer channel 484 is positioned such that the transfer pin 444 is seated against the indentation set 492. The connecting rod 410 is therefore withdrawn into the housing 330 and the plate 402 is at a first plate position, as shown in FIG. 14C, in which Port A communicates with Port C, Port D communicates with Port B, and Port E is blocked. As the arm 532 rotates, the passage 484 passes over the transfer pin 444, extending the plate 402 through the connecting rod 410 to a second plate position in which the transfer pin 444 engages the indentation set 494. In this position, all of Ports A-E are blocked as shown in FIG. 14B. Referring to FIG. 12, further rotation of the handle 340 depicted by arrow 594 aligns the transfer passage 484 with the transfer pin 444 at the indentation set 496, corresponding to a third plate position of maximum extension, in which Port A communicates with Port D, Port B communicates with Port E, and Port C is blocked, as shown in FIG. 14A. In this manner, the operator can adjust the plate 402 incrementally from the first plate position to the third plate position to control the fluid pathways of the valve 310. The indentations 492, 494, 496 are formed within the transfer passage 484 to correspond to the spacing of the notches 544 such that throughout this adjustment, once the operator obtains tactile feedback via the indentations 492, 494, 496 that a certain plate position is reached, release of the handle 340 will permit the spring 582 to bias the actuating member 532 to drive the respective notches 544 into engagement with the locking pins 574, as shown by arrow 598 in FIG. 13, to lock the handle, and thus the plate 402, in place.

Referring again to FIG. 12, rotation of the handle 340 beyond the third plate position described will align the end section 490 of the transfer path 484 with the transfer pin 444. When so aligned, the plate 402 is free to move between the first plate position and the third plate position, allowing remote operation of the control valve 310 via the solenoid.

Various features and advantages of the invention are set forth in the following claims.

1. A directional control valve assembly comprising:
a fluid control valve having a valve element defining a longitudinal axis along which the valve element is translatable, the valve element cooperative with one or more fluid passages to define fluid pathways to and from the fluid control valve;
a housing secured to the fluid control valve and positioned to receive a portion of a connecting member, the connecting member coupled to the valve element;
a handle pivotally connected to the housing and operatively coupled to the connecting member such that rotation of the handle causes translation of the valve element within the fluid control valve, the handle movable from a locked position to an unlocked position permitting handle rotation, wherein the handle is not biased by a spring into the locked position.

2. The assembly of claim 1, wherein the valve element is in the form of a spool.

3. The assembly of claim 1, wherein the valve element is in the form of a plate.

4. The assembly of claim 1, wherein the handle is not biased in the locked position.

5. The assembly of claim 1, wherein the fluid control valve is a solenoid-operated valve.

6. The assembly of claim 5, wherein the solenoid-operated valve is remotely operable.

7. The assembly of claim 1, wherein the fluid control valve is an air pilot operated valve.

8. The assembly of claim 7, wherein the air pilot operated valve is remotely operable.

9. The assembly of claim 1, wherein the handle is linearly movable between the unlocked and locked position.

10. The assembly of claim 9, wherein the housing includes a pivotable sleeve within which the handle is linearly movable.

11. The assembly of claim 10, wherein one of the sleeve and the handle includes a detent, and wherein the other of the sleeve and the handle includes a notch positioned to receive the detent.

12. The assembly of claim 11, wherein the notch is a first notch, and wherein the other of the sleeve and the handle includes a second notch positioned to receive the detent.

13. The assembly of claim 1, further including a locking member contained within the housing and cooperative with the handle to fix the position of the valve element.

14. The assembly of claim 13, wherein the locking member contained within the housing is a first locking member, the assembly further including a second locking member contained within the housing and cooperative with the handle to fix the position of the valve element.

15. The assembly of claim 14, wherein the handle is configured to receive the first locking member and is configured to receive the second locking member.

16. The assembly of claim 14, wherein the handle defines a recess, and wherein the recess is configured to receive the first locking member to fix the valve element in a first position and to receive the second locking member to fix the valve element in a second position.

17. The assembly of claim 14, wherein each of the first and second locking members are in the form of pins, each pin defining a parallel axis.

18. The assembly of claim 14, further including a third locking member contained within the housing and cooperative with the handle to fix the position of the valve element.

19. The assembly of claim 18, wherein the first, second, and third locking members are circumferentially spaced from each other.

20. A method for controlling the position of a directional control valve, the directional control valve including a solenoid-actuated plate and a handle operably coupled to the plate, the method comprising:
energizing the solenoid to move the plate to a first plate position;
manually pivoting the handle to move the plate to a second plate position;
moving the handle to lock the plate in the second plate position without the assistance of a biasing element.

21. The method of claim 20, wherein the moving the handle to lock the plate comprises manually translating the handle from a first linear handle position to a second linear handle position.

22. The method of claim 21, further including manually translating the handle from the second linear handle position to the first linear handle position and thereafter manually pivoting the handle to move the plate to a third plate position.

23. The method of claim 22, further including moving the handle to lock the plate in the third position without the assistance of a biasing element.

24. The method of claim 20, wherein the second plate position is one of a plurality of distinct plate positions.
